(19) United States
(12) Patent Application Publication
(10) Pub. No.: US 2025/0198432 A1
(43) Pub. Date: Jun. 19, 2025

(54) System And Method For Protecting A Hydraulic System Of A Work Machine

(71) Applicant: Komatsu America Corp., Chicago, IL (US)

(72) Inventor: Greggory Mann, Rocky Face, GA (US)

(73) Assignee: Komatsu America Corp., Chicago, IL (US)

(21) Appl. No.: 19/066,825

(22) Filed: Feb. 28, 2025

Related U.S. Application Data
(63) Continuation-in-part of application No. 18/817,434, filed on Aug. 28, 2024.
(60) Provisional application No. 63/579,434, filed on Aug. 29, 2023.

(51) Int. Cl. F15B 15/14; E02F 9/22; F16J 9/20

(52) U.S. Cl. CPC F15B 15/1428; E02F 9/2271; F16J 9/20

(57) ABSTRACT

A hydraulic cylinder for a work vehicle includes a cylinder extending between a first end and a second end. The cylinder includes a retention member positioned adjacent to the first end. The retention member includes threaded openings. A rod is disposed in the cylinder. A scraper assembly circumscribes the cylinder and the rod. The scraper assembly includes a collar arranged at the first end of the cylinder. The collar includes a first face surface and a second face surface. The collar includes a plurality of openings extending through the first face surface and the second face surface. A scraper ring is supported by the collar. A plurality of fasteners join the collar to the cylinder. Each of the plurality of fasteners extend through a corresponding one of the plurality of openings in the collar and engage a corresponding one of the plurality of threaded openings in the retention member.

### CROSS-REFERENCE TO RELATED APPLICATIONS

This application is a continuation-in-part of U.S. patent application Ser. No. 18/817,434, filed on Aug. 28, 2024, which claims the benefit of U.S. Provisional Application No. 63/579,434, filed on Aug. 29, 2023. The entire disclosures of the above applications are incorporated herein by reference.

### FIELD

The present disclosure relates to a device for a work machine, and in particular to a device and method for protecting a hydraulic cylinder assembly of a work machine.

### BACKGROUND

Work machines or vehicles, such as bulldozers, generally include hydraulic cylinder assemblies that are used to move one or more components of the machine for lifting or moving material in a work environment. Typical hydraulic cylinder assemblies include a piston rod that extends at least partially through a cylinder tube. The piston rod slides with respect to the tube between a first position, a second position, and positions therebetween, driving movement of the one or more components of the machine.

During operation of the machine in certain environments, like landfills or other locations in the waste industry, these hydraulic cylinders are exposed to debris (e.g., waste, garbage, mud, dirt, etc.). Flying debris, like plastic bags, may encounter the hydraulic cylinders, and there is a risk of such debris being sucked into the cylinders. This could lead to increased maintenance costs and machine downtime. The present disclosure provides a scraper assembly that may be removably installed onto a hydraulic cylinder to prevent or reduce debris from entering the hydraulic cylinder.

### SUMMARY

This section provides a general summary of the disclosure and is not a comprehensive disclosure of its full scope or all of its features.

A hydraulic cylinder for a work vehicle, in accordance with the present disclosure, includes a cylinder extending between a first end and a second end. The cylinder includes a retention member positioned adjacent to the first end. The retention member includes a plurality of threaded openings. A rod is slidingly disposed in the cylinder. A scraper assembly circumscribes the cylinder and the rod. The scraper assembly includes a collar arranged at the first end of the cylinder. The collar includes a first face surface and a second face surface axially spaced from the first face surface. The collar includes a plurality of openings extending through the first face surface and the second face surface. A scraper ring is supported by the collar. A plurality of fasteners join the collar to the cylinder. Each of the plurality of fasteners extend through a corresponding one of the plurality of openings in the collar and engage a corresponding one of the plurality of threaded openings in the retention member.

In some configurations, the collar includes a first collar portion and a second collar portion, the first collar portion including a first discontinuity and the second collar portion including a second discontinuity, wherein when mounted to the cylinder, the first discontinuity and the second discontinuity form a V-shaped notch section in the collar.

In some configurations, the collar includes an outer surface and an annular inner surface radially spaced from the outer surface, the annular inner surface including an annular groove that is receptive of the scraper ring.

In some configurations, a plate is positioned on the first face surface of the collar, the plurality of fasteners passing through the plate and the collar and engaging the threaded openings in the retention member.

In some configurations, the plate includes a partially annular surface including a plate discontinuity.

In some configurations, when the plate is mounted to the first face surface, the plate discontinuity is aligned with the V-shaped notch section in the collar.

In some configurations, a sensor housing is mounted at the first end, the V-shaped notch section extending about a portion of the sensor housing.

In some configurations, the plurality of openings comprises a plurality of elongated openings.

In some configurations, each of the plurality of elongated openings includes a curvilinear profile.

A hydraulic cylinder for a work vehicle, in accordance with the present disclosure, includes a cylinder extending between a first end and a second end. A retention member is mounted at the first end of the cylinder. A rod is slidingly disposed in the cylinder. A sensor housing mounted at the first end of the hydraulic cylinder. A scraper assembly circumscribes the cylinder and the rod. The scraper assembly includes a collar extending arranged at the first end of the cylinder. The collar includes a V-shaped notch portion that extends about a portion of the sensor housing. A scraper ring is mounted in the collar, the scraper ring engaging the rod.

In some configurations, the collar includes a first face surface, a second face surface axially spaced from the first face surface, and plurality of openings extending through the first face surface and the second face surface.

In some configurations, the retention member includes a plurality of threaded openings.

In some configurations, a plurality of fasteners join the collar to cylinder, each of the plurality of fasteners extending through a corresponding one of the plurality of openings in the collar and engaging a corresponding one of the plurality of threaded openings in the retention member.

In some configurations, each of the plurality of openings comprises an elongated opening.

In some configurations, the elongated opening includes a curvilinear profile.

A method of assembling a scraper assembly onto a hydraulic cylinder for a work vehicle, in accordance with the present disclosure, includes positioning collar including a plurality of openings and a scraper ring about a rod at a first end of the hydraulic cylinder, rotating the collar to align the plurality of openings in the collar with a plurality of opening elements formed in a retention member mounted to the first end of the hydraulic cylinder, passing a fastener through each of the plurality of openings in the collar into each of the plurality of opening elements in the retention member, and tightening the fastener.

In some configurations, rotating the collar includes aligning a V-shaped notch portion in the collar with a sensor housing mounted at the first end of the hydraulic cylinder.

In some configurations, positioning the collar includes placing a plate on the collar.

In some configurations, passing the fastener through each of the plurality of openings in the collar includes first passing the fastener through an opening formed in the plate arranged on the collar.

In some configurations, rotating the collar includes aligning a plurality of elongated openings defining the plurality of openings in the collar with a plurality of threaded openings defining the plurality of openings in the retention member.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a schematic of a work machine having a hydraulic cylinder including a scraper assembly according to the principles of the present disclosure;

FIG. 2 is a perspective view of the hydraulic cylinder of FIG. 1;

FIG. 3 is a partially exploded view of a portion of the hydraulic cylinder of FIG. 2;

FIG. 4 is a cross-sectional view of the hydraulic cylinder of FIG. 2 including a scraper assembly taken along line A-A of FIG. 2;

FIG. 5A is a front perspective view of the scraper assembly of FIG. 4;

FIG. 5B is a rear perspective view of the scraper assembly of FIG. 4;

FIG. 5C is a cross-sectional view of the scraper assembly of FIGS. 5A-5B taken along line 5C-5C of FIGS. 5A and 5B;

FIG. 6A is a front perspective view of a scraper ring of the scraper assembly of FIGS. 4 and 5A-5C;

FIG. 6B is a rear perspective view of the scraper ring of FIG. 6A;

FIG. 7 is a cross-sectional view of the hydraulic cylinder of FIG. 2 including another scraper assembly taken along line A-A of FIG. 2;

FIG. 8A is a front perspective view of the scraper assembly of FIG. 7;

FIG. 8B is a rear perspective view of the scraper assembly of FIG. 7;

FIG. 8C is a cross-sectional view of the scraper assembly of FIGS. 8A-8B taken along line 8C-8C of FIGS. 8A and 8B;

FIG. 9A is a front perspective view of a seal of the scraper assembly of FIGS. 7 and 8A-8C;

FIG. 9B is a rear perspective view of the seal of FIG. 9A;

FIG. 10 is a flowchart of a method of installing a scraper assembly onto the hydraulic cylinder;

FIG. 11 is a partially disassembled perspective view of a portion of a hydraulic cylinder of a work machine, in accordance with related art;

FIG. 12 is a perspective view of the hydraulic cylinder including a scraper assembly, in accordance with the present disclosure;

FIG. 13 is a perspective view of a scraper keeper mounted to the scraper assembly of FIG. 12, in accordance with the present disclosure;

FIG. 14 is a plan view of a scraper support portion and scraper of the scraper assembly of FIG. 12, in accordance with the present disclosure; and

FIG. 15 is a partial cross-sectional view showing the scraper abutting the hydraulic cylinder, in accordance with the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

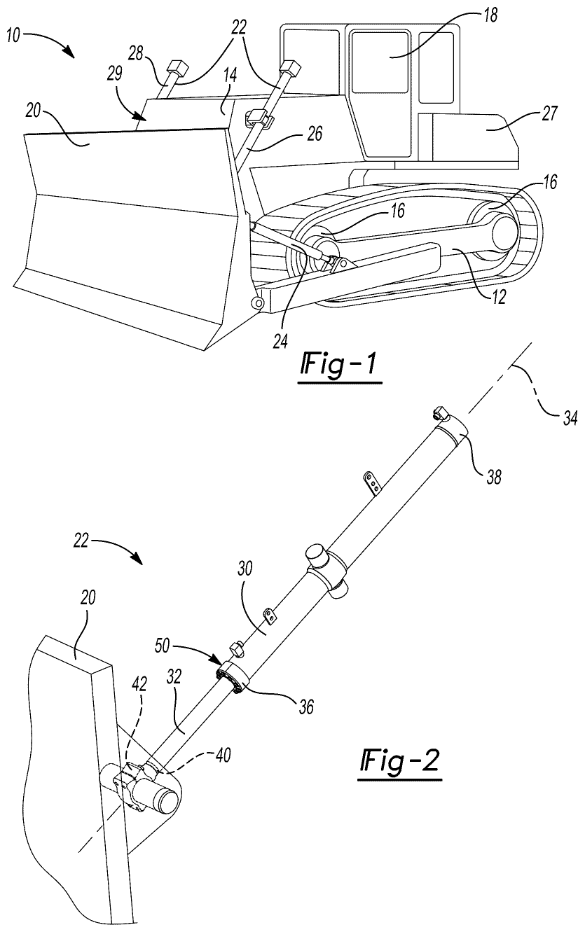

With reference to FIG. 1, a work vehicle 10 (e.g., a work machine) is provided. The work vehicle 10 shown in the figures is a bulldozer. However, it will be appreciated that the principles of the present disclosure are applicable to other types of work vehicles and machines such as those used in waste management, construction, mining, or transportation industries. Moreover, the present disclosure is applicable to other types of machines including one or more moving rods, hydraulic cylinders, and/or joints that are susceptible to debris ingression.

The work vehicle 10 may include a vehicle frame or chassis 12, a body 14 mounted to the chassis 12, a plurality of wheels 16 supported by the chassis 12, a drive system (not shown), an operator cab 18, and a blade 20. The blade 20 may be movably connected to the body 14 via a first set of hydraulic cylinders 22 (also referred to as the “first hydraulic cylinder assembly 22”). Additionally, or alternatively, the blade 20 may be movably coupled to the chassis 12 via a second set of hydraulic cylinders 24 (also referred to as the “second hydraulic cylinder assembly 24”). The first set of hydraulic cylinders 22 includes a first hydraulic cylinder 26 mounted to a first side 27 of the work vehicle 10 and a second hydraulic cylinder 28 mounted to a second side 29 of the work vehicle 10. The first set of hydraulic cylinders 22 and the second set of hydraulic cylinders 24 cooperate to move the blade 20 in one or more directions during operation of the work vehicle 10. For example, the blade 20 may be movable in a first (e.g., up/down) direction, second (e.g., fore/aft) direction, a third (e.g., tilted in plane) direction, and optionally a fourth (e.g., swiveled) direction to clear and/or relocate waste, rubble, dirt, etc.

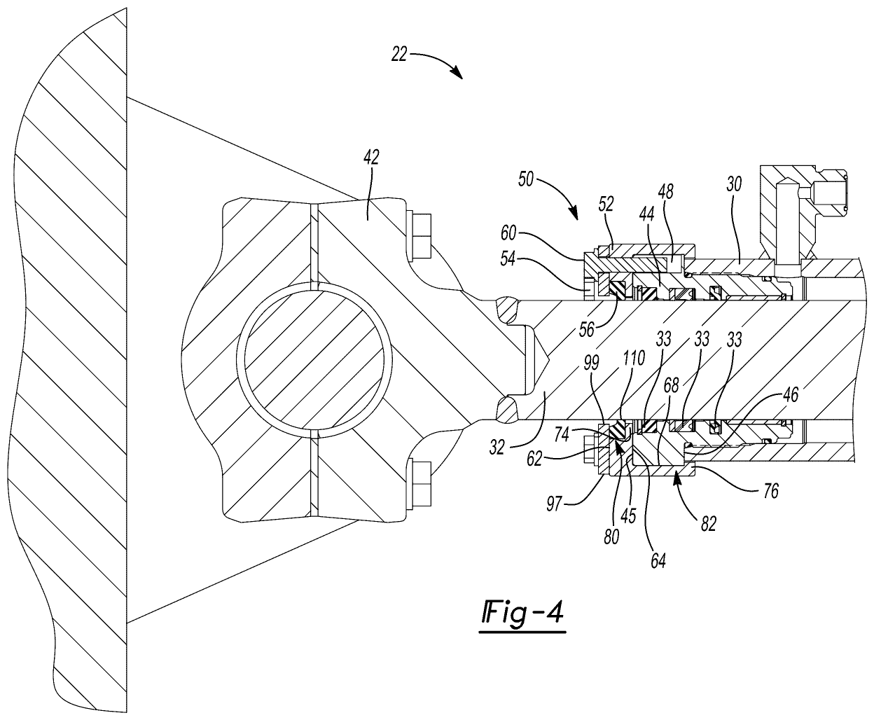

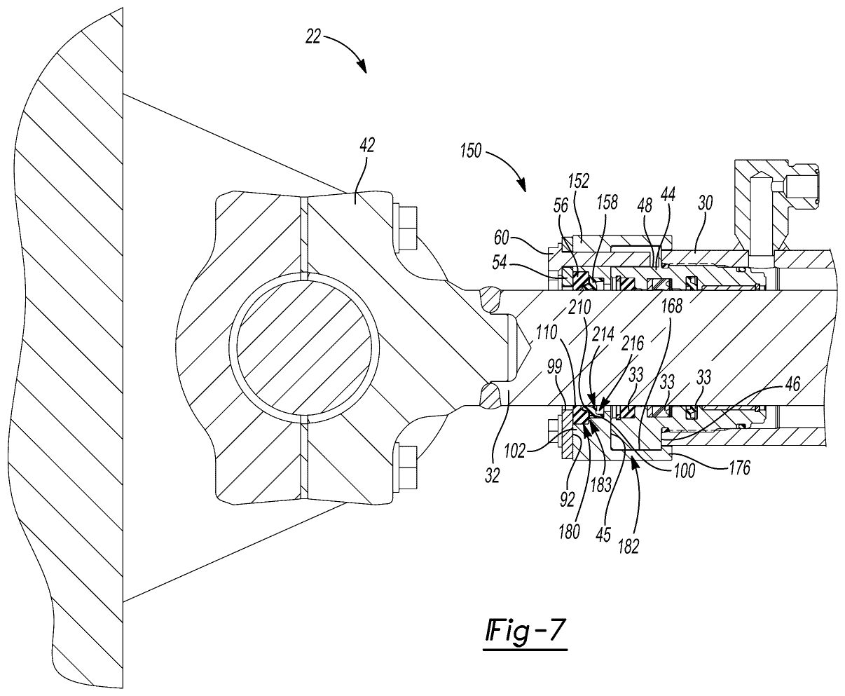

With reference to FIGS. 2-4, the first hydraulic cylinder assembly 22 is shown. While FIG. 2-4 show only the first hydraulic cylinder assembly 22, it is to be understood that the second hydraulic cylinder assembly 24 may also include the features described below for the hydraulic cylinder assembly 22. The hydraulic cylinder assembly 22 includes a cylinder 30 (e.g., a pressure tube), a movable piston rod 32 (i.e., the “rod 32”), a piston assembly (not shown), and one or more seals 33 (FIGS. 4 and 7) circumscribing the rod 32. The cylinder 30 extends axially along a longitudinal axis 34 from a first end 36 to a second end 38. The piston assembly is slidably disposed within the cylinder 30. The rod 32 extends axially along the axis 34 from a first end 40 connected to an attachment body 42 (e.g., a rod eye) and a second end (not shown) connected to the piston assembly. At least a portion of the rod 32 is slidably disposed within the cylinder 30 and movable between a first position (e.g., a fully retracted position), a second position (e.g., a fully extended position), and a plurality of positions therebetween.

The cylinder 30 is fixed to the body 14 of the work vehicle 10. For example, the cylinder 30 may be fixed via one or more fasteners (e.g., nuts, bolts, rivets, ties), brackets, or links. The rod 32 may be fixed (e.g., rotatably fixed) to the blade 20 of the work vehicle 10, such as via the attachment body 42.

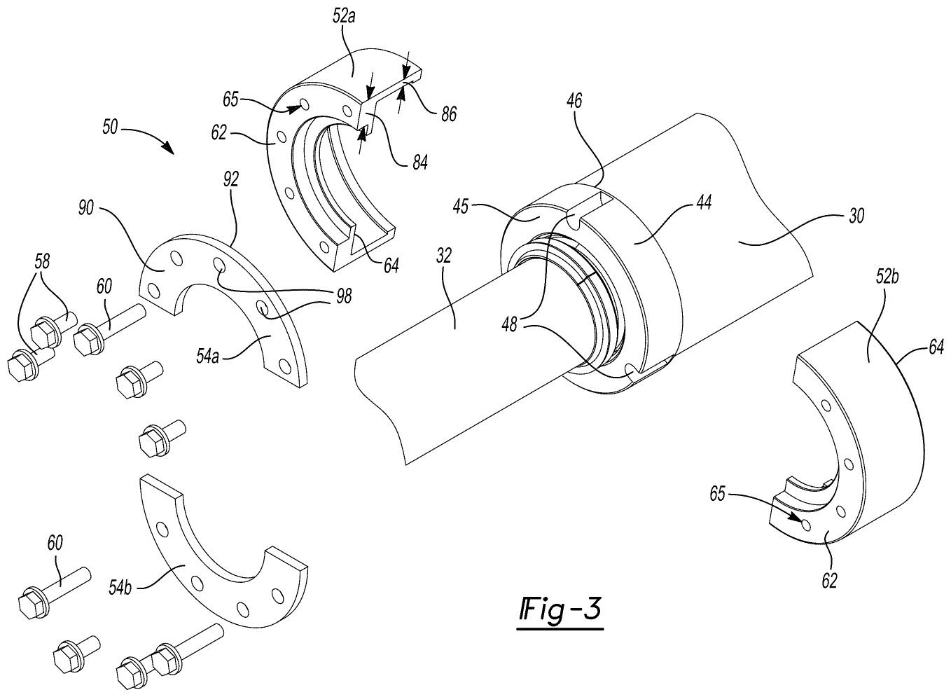

As best shown in FIG. 3, the first end 36 of the cylinder 30 may include a lip or retention feature 44. The retention feature 44 may be integrally formed with the cylinder 30. Alternately, the retention feature 44 may be joined (e.g., fastened) to the cylinder 30. The retention feature 44 may project radially outward from the cylinder 30 such that a diameter of the retention feature 44 is greater than a diameter of the cylinder 30. The retention feature 44 extends between a first surface 45 and an axially spaced second surface 46. While FIG. 3 shows the retention feature 44 circumscribing the entire cylinder 30, it is contemplated that alternate embodiments the retention feature 44 extends from only a portion cylinder 30 (e.g., the retention feature 44 may include one or more radially extending protrusions).

The retention feature 44 defines one or more grooves or notches 48. The notches may extend from the first surface 45 towards the second surface 46. The notches 48 may have a generally semi-circular shape, although other shapes and configurations are contemplated. The notches 48 are configured to receive fasteners therein (see, e.g., the first plurality of fasteners 60). In the configuration shown in FIG. 3, the retention feature 44 includes two notches 48 that are spaced apart around the retention feature 44. For example, each of the notches 48 may be spaced apart at an angle of about 180 degrees. It is contemplated that the retention feature 44 may include more or less than two notches 48 and/or notches 48 positioned at different spacings around the retention feature 44. For example, the retention feature 44 may include four notches 48 spaced apart at an angle of about 90 degrees. In another example, the retention feature 44 may include three notches 48 spaced apart at an angle of about 60 degrees.

A scraper assembly 50 is removably installed onto the hydraulic cylinder assembly 22 at or near the first end 36 of the cylinder 30. As will be described in greater detail below, when installed, the scraper assembly 50 is fixed to and circumscribes the cylinder 30 and the rod 32. The scraper assembly is configured to prevent debris (e.g., plastic bags, garbage, waste, etc.) from entering the cylinder 30, thereby reducing the amount of debris trapped in the cylinder 30.

Referring to FIGS. 3-6B, the scraper assembly 50 includes a collar 52, a plate 54, and a scraper ring 56. The scraper assembly 50 may also include a first plurality of fasteners 60 (e.g., bolts, nuts, rivets, ties, brackets, links, adhesives, etc.) and a second plurality of fasteners 58 (e.g., bolts, nuts, rivets, ties, brackets, links, adhesives, etc.). In one example, the first plurality of fasteners 60 are bolts having a first length and the second plurality of fasteners 58 are bolts having a second length that is less than the first length.

Each of the collar 52, the plate 54, and the scraper ring 56 include at least two distinct pieces that are joined or coupled together during assembly. In this way, the scraper assembly 50 may be removably installed to the hydraulic cylinder assembly 22 after the assembly of the work vehicle 10 (e.g., by retrofitting at a dealership or after-market facility), thereby eliminating or reducing the additional work required to service and retrofit the hydraulic cylinder assembly 22 to install a scraper assembly. For example, the scraper assembly 50 may be installed and/or removed from the hydraulic cylinder assembly 22 without disassembling the hydraulic cylinder assembly 22. It follows that the scraper assembly 50 including the collar 52, plate 54, and scraper ring 56, each having at least two pieces, facilitates efficient and cost-effective assembly onto and removal from the hydraulic cylinder assembly 22 compared to conventional assemblies.

The collar 52 may be formed of a metallic material, a polymeric material, or a composite material. The collar 52 includes a first collar 52a (e.g., a first semi-circular collar) and a second collar 52b (e.g., a second semi-circular collar) (collectively the “collars 52a, 52b”). Each of the collars 52a, 52b extends between a first surface 62 and an axially spaced second surface 64. The first surface 62 defines a plurality of apertures 65 extending therethrough. Each of the collars 52a, 52b includes an outer surface 66 and an inner surface 68 spaced radially inward from the outer surface 66. Each of the collars 52a, 52b may extend in a semi-circular shape between a first end 70 and a second end 72. A first step or flange 74 extends radially inward from the inner surface 68 and is positioned between the first surface 62 and the second surface 64. A second step or flange 76 extends radially inward from the inner surface 68 and is positioned adjacent to the second surface 64. The first step or flange 74 defines a first or ring engaging portion 80 (FIG. 4) between the first surface 62 and the step 74 and a second or cylinder engaging portion 82 between the step 74 and the second surface 64. A first thickness 84 (FIG. 3) of the ring engaging portion 80 is greater than a second thickness 86 of the cylinder engaging portion 82 such that a first dimension (e.g., a first diameter) of the ring engaging portion 80 is less than a second dimension (e.g., a second diameter) of the cylinder engaging portion 82.

When installed, the first collar 52a and the second collar 52b cooperate to circumscribe the cylinder 30 and rod 32. Specifically, the first end 70 of the first collar 52a abuts and contacts the first end 70 of the second collar 52b and the second end 72 of the first collar 52a abuts and contacts the second end 72 of the second collar 52b. As best shown in FIG. 4, the first step 74 of each of the collars 52a, 52b engages the first surface 45 of the retention feature 44. The first step 74 is slightly spaced apart from the rod 32 (e.g., in a radial direction), defining a gap therebetween. The second step 76 of each of the collars 52a, 52b engages the second surface 46 of the retention feature 44. The inner surface 68 of the cylinder engaging portion 82 of the collars 52a, 52b may contact the retention feature 44.

The plate 54 may be formed of a metallic, polymeric, or composite material. The plate 54 includes a first plate 54a (e.g., a first semi-circular plate) and a second plate 54b (e.g., a second semi-circular plate) (collectively the “plates 54a, 54b”). Each of the plates 54a, 54b extend between a first surface 90 and an axially spaced second surface 92. The plates 54a, 54b extend in a semi-circular shape between a first end 94 and a second end 96. The plates 54a,54b include an outer surface 97 and an inner surface 99 spaced radially inward from the outer surface 97. The plates 54a, 54b define a plurality of apertures 98 extending between the first surface 90 and the second surface 92.

When installed, the first plate 54a and the second plate 54b cooperate to circumscribe the rod 32. Specifically, the first end 94 of the first plate 54a abuts and contacts the first end 94 of the second plate 54b and the second end 96 of the first plate 54a abuts and contacts the second end 96 of the second plate 54b. As best shown in FIG. 4, the inner surface 99 of the plates 54a, 54b is slightly spaced apart from (i.e., provides a clearance or gap to) the rod 32.

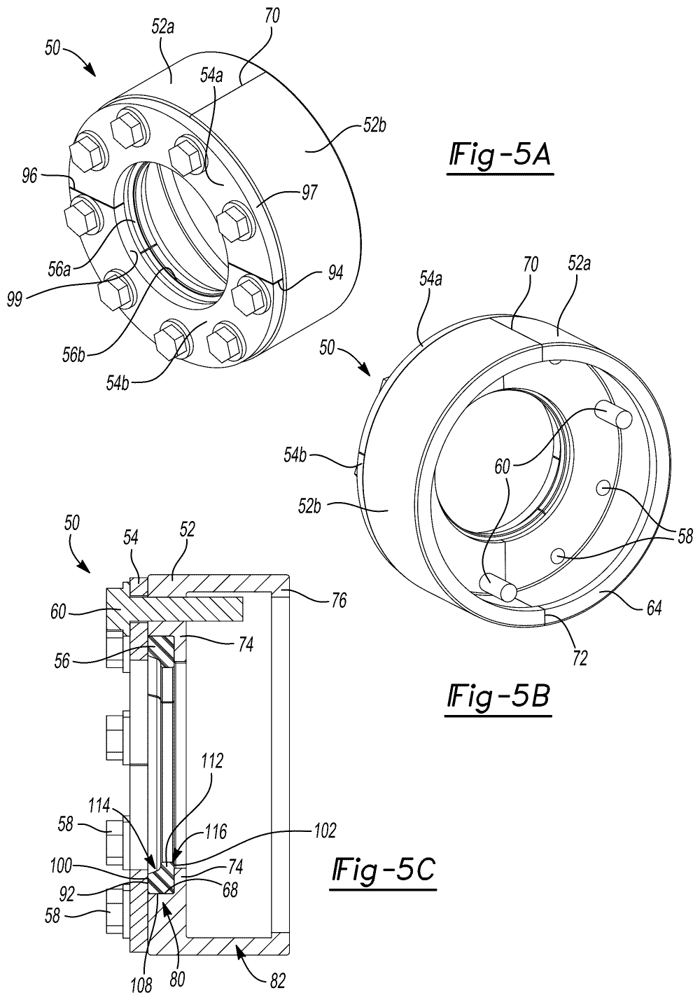

As best shown in FIGS. 5A-5B, the joined ends 94, 96 of the plates 54a, 54b are offset from the joined ends 70, 72 of the collars 52a, 52b. In the configuration shown in FIGS. 3-6B, the offset is about 90 degrees. In this way, the second surface 92 of the first plate 54a contacts both the first surface 62 of the first collar 52a and the first surface 62 of the second collar 52b. Similarly, the second surface 92 of the second plate 54b contacts both the first surface 62 of the first collar 52a and the first surface 62 of the second collar 52b.

The plurality of apertures 98 of the plates 54a, 54b are aligned with the plurality of apertures 65 of the collars 52a, 52b. The second plurality of fasteners 58 are received in a portion of the apertures 95, 98 to secure and retain the plates 54a, 54b to the collars 52a, 52b and thereby retain the collars 52a, 52b to the cylinder 30.

At least two of the plurality of apertures 98 of the plates 54a, 54b are aligned with the notches 48 of the retention feature 44. The first plurality of fasteners 60 are received in the apertures 98 and the notches 48. The first plurality of fasteners 60 retain the plates 54a, 54b and collars 52a, 52b to the cylinder 30 and also reduce rotation of the plates 54a, 54b and/or collars 52a, 52b during operation of the hydraulic cylinder assembly 22. It is contemplated that some rotational movement of the collar may be permitted to reduce stress during operation and prevent mechanical failure.

The scraper ring 56 is formed of a metallic material. The metallic material may include brass, copper, zinc, lead, tin, manganese, nickel, iron, alloys thereof, and/or combinations thereof. The scraper ring 56 is configured to prevent or inhibit debris from entering the cylinder by contacting or “scraping” the rod 32 as it moves between its fully extended and fully retracted positions. As such, the scraper ring 56 must exhibit a hardness, strength, and durability sufficient to effectively remove debris from the rod 32 while minimizing wear (e.g., scratching) of the rod 32.

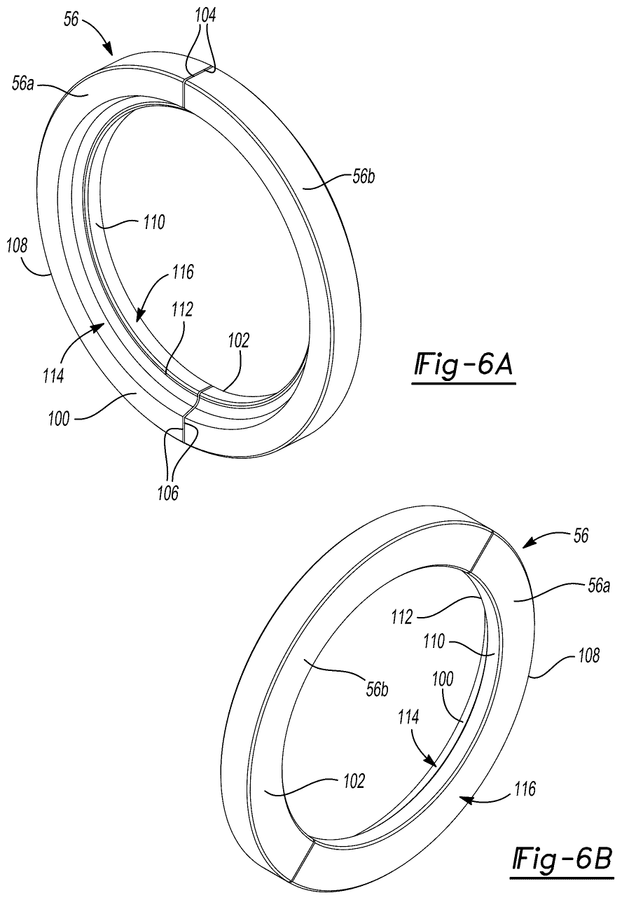

Referring to FIGS. 6A and 6B, the scraper ring 56 includes a first ring 56a (e.g., a first semi-circular ring) and a second ring 56b (e.g., a second semi-circular ring) (collectively the “rings 56a, 56b”). Each of the rings 56a, 56b extend between a first surface 100 and an axially extending spaced second surface 102. The rings 56a, 56b extend in a semi-circular shape between a first end 104 and a second end 106. The rings 56a, 56b include an outer surface 108 and an inner surface 110. A flange or step 112 extends radially inward from the inner surface 110 and is positioned between the first surface 100 and the second surface 102. The step 112 defines a first or cavity portion 114 between the first surface 100 and the step 112 and a second or rod engaging portion 116 between the step 112 and the second surface 102. A first thickness of the cavity portion 114 is less than a second thickness of the rod engaging portion 116 such that a first dimension (e.g., a first diameter) of the cavity portion 114 is greater than a second dimension (e.g., a second diameter) of the rod engaging portion 116.

With renewed reference to FIGS. 4 and 5A-5C, when installed, the first ring 56a and the second ring 56b cooperate to circumscribe the rod 32. Specifically, the first end 104 of the first ring 56a abuts and contacts the first end 104 of the second ring 56b and the second end 106 of the first ring 56a abuts and contacts the second end 106 of the second ring 56b.

The collar 52 and the plate 54 cooperate to retain the scraper ring 56 around the rod 32. Specifically, the collar 52 and the plate 54 cooperate to compress the scraper ring 56 radially inward around the rod 32. The scraper ring 56 is positioned within the ring engaging portion 80 of the collar 52 such that the inner surface 68 of the collar 52 contacts the outer surface 108 of the scraper ring 56 (see, e.g., FIG. 5C). The first surface 100 of the scraper ring 56 contacts the second surface 92 of the plate 54. The second surface 102 of the scraper ring 56 contacts the step 74 of the collar 52. The inner surface 110 of the rod engaging portion 116 contacts the rod 32. The inner surface 110 of the cavity portion 114 is spaced apart from the rod 32, defining a gap therebetween (see, e.g., FIG. 4).

As the rod 32 moves between the first (e.g., fully extended) position and the second (e.g., fully retracted) position, debris may attach to the rod 32. The scraper ring 56, which is retained in position by the collar 52 and the plate 54, contacts the rod 32. The plate 54 and the collar 52 cooperate to radially compress the scraper ring 56 against the rod 32. The interference between the scraper ring 56 and the rod 32 prevents debris from entering into the cylinder 30 and/or building up on the rod 32. Thus, the hydraulic cylinder assembly 22 is less likely to require maintenance during its life cycle as compared to a hydraulic cylinder assembly that is free of a scraper assembly. Retaining the scraper ring 56 in this manner axially restrains the scraper ring 56 and limits deformation that may result from movement of the rod 32 during operation.

With reference to FIGS. 7-9B, the hydraulic cylinder assembly 22 including the cylinder 30 and rod 32 is shown including a scraper assembly 150. The scraper assembly 150 may be the same as or similar to the scraper assembly 50 of FIGS. 3-6B, except as otherwise described below. The scraper assembly 150 includes a collar 152, the plate 54, the scraper ring 56, and a scraper seal 158.

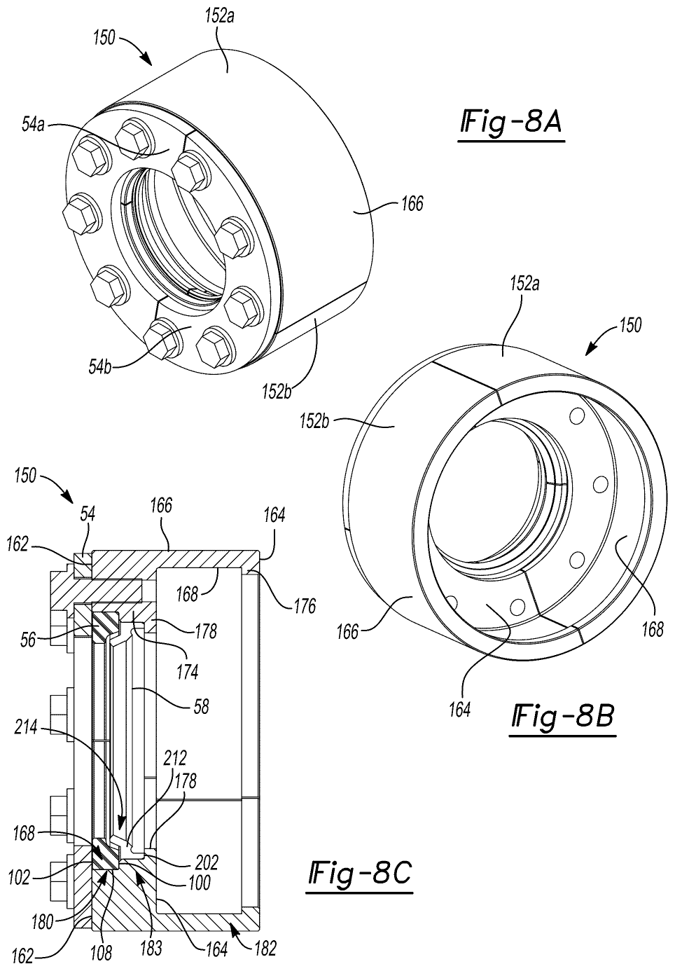

As best shown in FIG. 8C, the collar 152 includes a first collar 152a (e.g., a first semi-circular collar) and a second collar 152b (e.g., a second semi-circular collar) (collectively the “collars 152a, 152b”). Each of the collars 152a, 152b extends between a first surface 162 and an axially spaced second surface 164. The first surface 162 defines a plurality of apertures (not shown) extending therethrough. The collars 152a, 152b include an outer surface 166 and an inner surface 168 spaced radially inward from the outer surface 166. Each of the collars 152a, 152b may extend in a semi-circular shape between a first end 170 and a second end 172. A first step or flange 174 extends radially inward from the inner surface 168 and is positioned between the first surface 162 and the second surface 164. A second step or flange 176 extends radially inward from the inner surface 168 and is positioned adjacent to the second surface 164. A third step or flange 178 extends radially inward from the inner surface 168 and is positioned between the first step 174 and the second step 176. A first or ring engaging portion 180 is defined between the first surface 162 and the first step 160. A second or cylinder engaging portion 182 is defined between the second step 176 and the third step 178. A third or seal engaging portion 183 is defined between the first step 174 and the second step 176.

As best shown in FIG. 7, when installed, the third step 178 of each of the collars 152a, 152b engages the first surface 45 of the retention feature 44. The third step 178 is slightly spaced apart from the rod 32 (e.g., in a radial direction), defining a gap therebetween. The first step 174 is also spaced apart from the rod 32, defining a gap therebetween. The second step 176 of each of the collars 152a, 152b engages the second surface 46 of the retention feature 44. The inner surface 168 of the cylinder engaging portion 182 of the collars 152a, 152b may contact the retention feature 44.

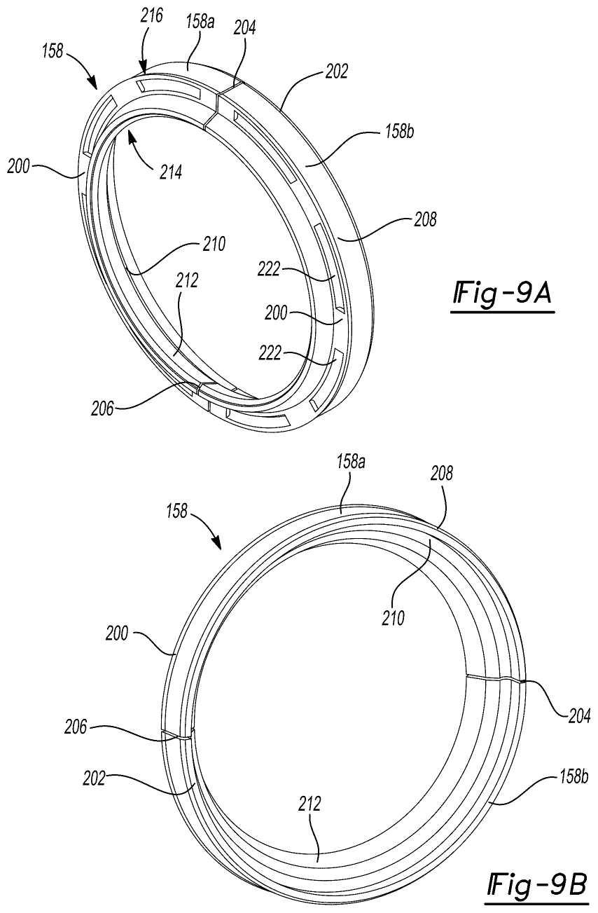

Referring to FIGS. 9A-9B, the scraper seal 158 includes a first seal 158a (e.g., a first semi-circular seal) and a second seal 158b (e.g., a second semi-circular seal) (collectively the “seals 158a, 158b”). Each of the seals 158a, 158b extend between a first surface 200 and an axially spaced second surface 202. The seals 158a, 158b extend in a semi-circular shape between a first end 204 and a second end 206. The seals 158a, 158b include an outer surface 208 and an inner surface 210. A flange or step 212 extends radially inward from the inner surface 210 and is positioned between the first surface 200 and the second surface 202. The step 212 defines a first portion 214 between the first surface 200 and the step 212 and a second portion 216 between the step 212 and the second surface 202. Each of the outer surface 208 and inner surface 210 of the first portion 214 extend to the first surface 200 at an angle (i.e., the first portion 214 is chamfered). A surface 220 of the step 212 defines a plurality of grooves 222 therein. The plurality of grooves 222 are spaced circumferentially around the step 212.

When installed, the first seal 158a and the second seal 158b cooperate to circumscribe the rod 32. Specifically, the first end 204 of the first seal 158a abuts and contacts the first end 204 of the second seal 158b. The second end 206 of the first seal 158a abuts and contacts the second end 206 of the second seal 158b.

The collar 52 and the plate 54 cooperate to retain the scraper ring 56 and the scraper seal 158 around the rod 32. At least a portion of the scraper ring 56 and the scraper seal 158 contact the rod 32 to prevent debris from entering the cylinder 30.

The scraper ring 56 is positioned within the ring engaging portion 180 of the collar 152. The scraper ring 56 of the scraper assembly 150 is oriented in the opposite direction as compared to the scraper ring 56 of the scraper assembly 50. In other words, in the configuration of FIGS. 7-9B, the scraper ring 56 is flipped about 180 degrees relative to its orientation in the scraper assembly 50. In this way, the second surface 102 of the scraper ring 56 abuts and contacts the second surface 92 of the plate 54 and the first surface 100 of the scraper ring 56 contacts the first step 174 of the collar 152. The inner surface 168 of the collar contacts the outer surface 108 of the scraper ring 156.

The scraper seal 158 is positioned within the seal engaging portion 183 of the collar 152. The second surface 202 of the scraper seal 158 abuts and contacts the third step 178 of the collar 152. The scraper seal 158 at least partially engages the scraper ring 56. Specifically, the first surface 100 of the scraper ring 56 contacts the surface 220 of the step 212 of the scraper seal 158. Additionally, the inner surface 110 of the cavity portion 114 of the scraper ring 56 contacts the outer surface 208 of the first portion 214 of the scraper seal 158. The inner surface 110 of the cylinder engaging portion 116 of the scraper ring 56 and the inner surface 210 of the first portion 214 of the scraper seal 158 contact the rod 32.

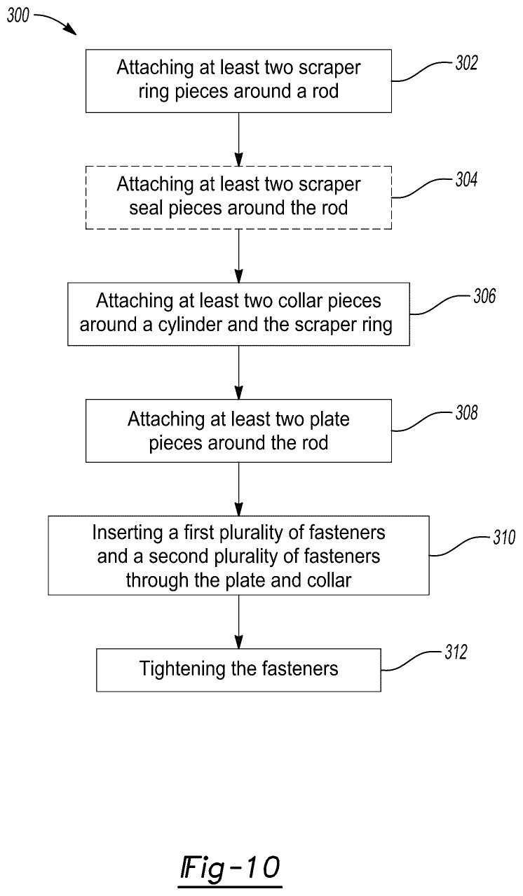

With reference to FIG. 10, a method 300 of assembling a scraper assembly onto a hydraulic cylinder assembly is provided. The hydraulic cylinder assembly includes a cylinder and a movable rod. At 302, the method 300 includes attaching at least two scraper ring pieces around the rod. The attaching may include positioning a first semi-circular scraper ring and a second semi-circular scraper ring around the rod at a pre-determined distance from an end of the rod. At 304, the method 300 may optionally include attaching at least two scraper seal pieces around the rod. The attaching may include positioning a first semi-circular scraper seal and a second semi-circular scraper seal around the rod adjacent to the scraper ring.

Next, at 306, the method 300 includes attaching at least two collar pieces around the cylinder and the scraper ring (and optionally the scraper seal). The attaching may include positioning a first semi-circular collar and a second semi-circular collar around a retention feature of the cylinder. The cylinder may define pre-formed notches. The attaching may include aligning the collar with the pre-formed notches of the retention feature.

Next, at 308, the method 300 includes attaching two plate pieces around the rod. For example, the attaching may include positioning a first semi-circular plate and a second semi-circular plate around the rod such that a surface of each of the first semi-circular plate and the second semi-circular plate contacts a surface of both of the first semi-circular collar and the second semi-circular collar.

At 310, the method includes inserting a first plurality of fasteners and a second plurality of fasteners through the plate and collar. The first plurality of fasteners may be received in the notches of the retention feature. At 312, the method 300 includes tightening the fasteners. In this way, the plate and the collar cooperate to retain the scraper ring, and optionally the scraper seal, against the rod.

The method 300 may optionally include removing the scraper assembly from the hydraulic cylinder assembly. It should be appreciated that the method 300 does not require any disassembly of the hydraulic cylinder assembly to install or remove the scraper assembly.

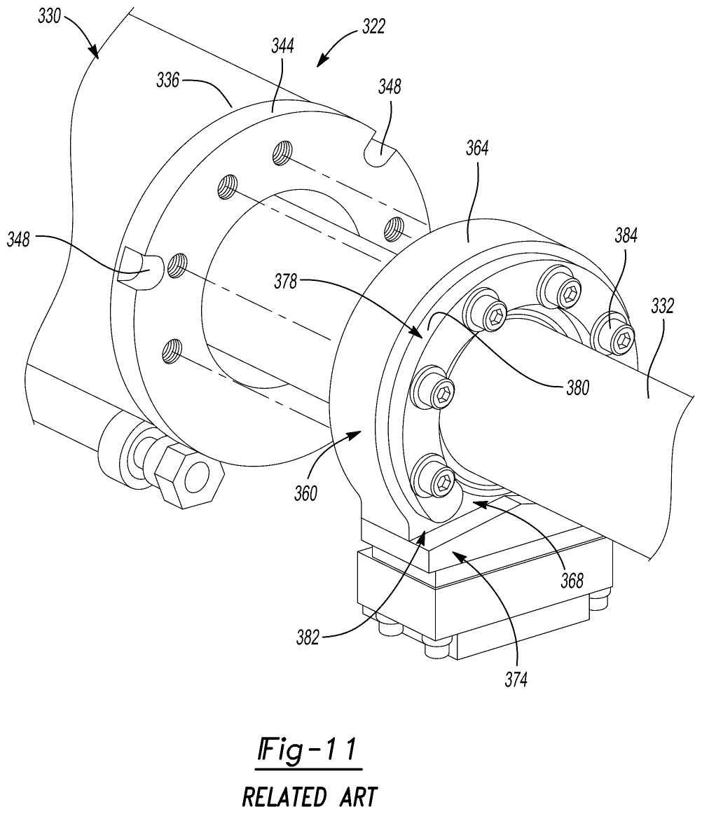

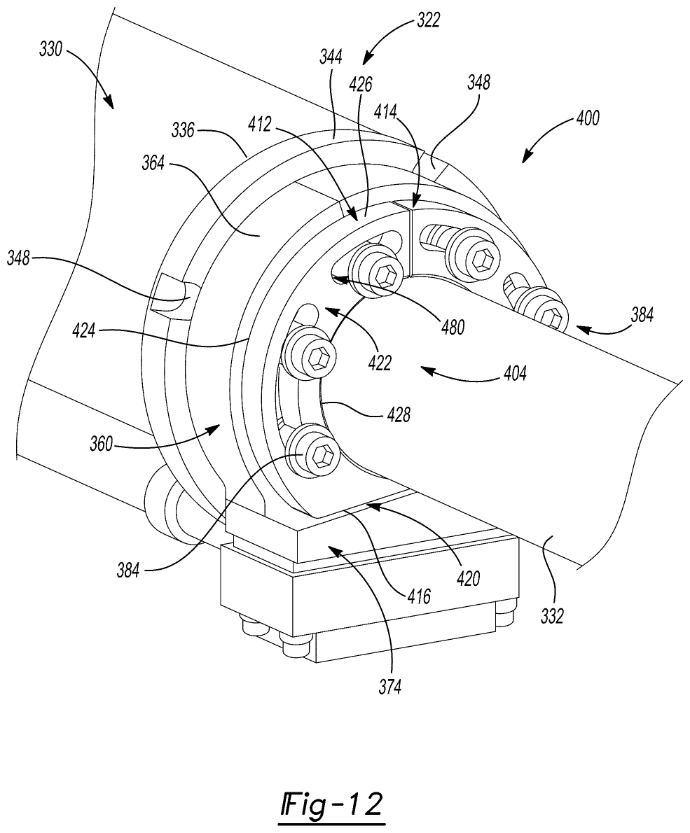

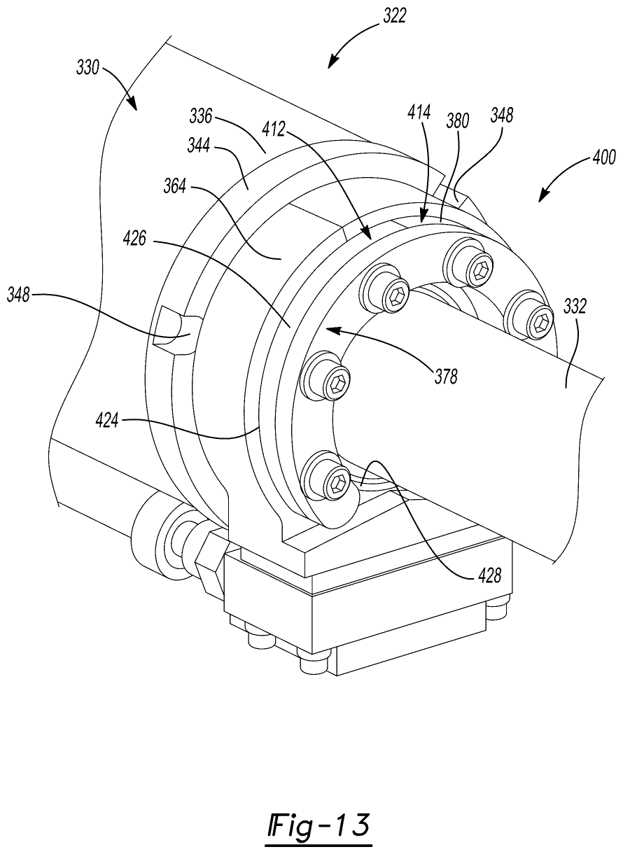

Reference will now follow to FIG. 11 in describing a hydraulic cylinder assembly 322 in accordance with the prior art. Hydraulic cylinder assembly 322 includes a cylinder 330 that supports a moveable piston rod 332. Cylinder 330 includes a first end 336 to which is mounted a retention member 344. Retention member 344 secures internal rod components (not shown) within cylinder 330. Retention member 344 includes a plurality of threaded opening elements 346 and plurality of notches 348. Notches 348 are configured to be engaged by a tool, such as a ring spanner, that rotates and secures retention member 344 to first end 336 of cylinder 330.

Cylinder 330 also supports a seal guard 360 that supports and protects seals (not shown) arranged at first end 336 of cylinder 330. The seals support hydraulic pressure in cylinder 330 as well as prevent debris from entering cylinder 330. Seal guard 360 includes an outer curvilinear surface 364 including a V-notch 368. V-notch 368 is positioned to accommodate a sensor assembly 377 mounted at first end 336 of cylinder 330. Sensor assembly 374 may be configured to detect a position of rod 332 relative to cylinder 330. The position is provided as feedback to operators of work vehicle 10.

A plate or seal guard retainer 378 supports seal guard 360. Plate 378 evenly distributes a retention force applied to seal guard 360. Plate 378 includes a partially annular surface 380 and includes a discontinuity 382 that accommodates sensor assembly 374. Seal guard 360 is secured to retention member 344 by a plurality fasteners 384. Fasteners 384 are pass through plate 378, through seal guard 360 and engage the threaded opening elements 346 formed in retention member 344. Fasteners 384 are tightened against plate 378.

As discussed herein, work vehicle 10 may, at times operate in harsh environments. The harsh environments may overcome any protection provided by seal guard 360. As such, a scraper assembly 400, as shown in FIG. 12, may be mounted to first end 336 of cylinder 330. In a manner similar to that discussed herein, scraper assembly 400 is configured to prevent debris (e.g., plastic bags, garbage, waste, etc.) from entering the cylinder 330 thereby increasing a need for maintenance cycles for work vehicle 10.

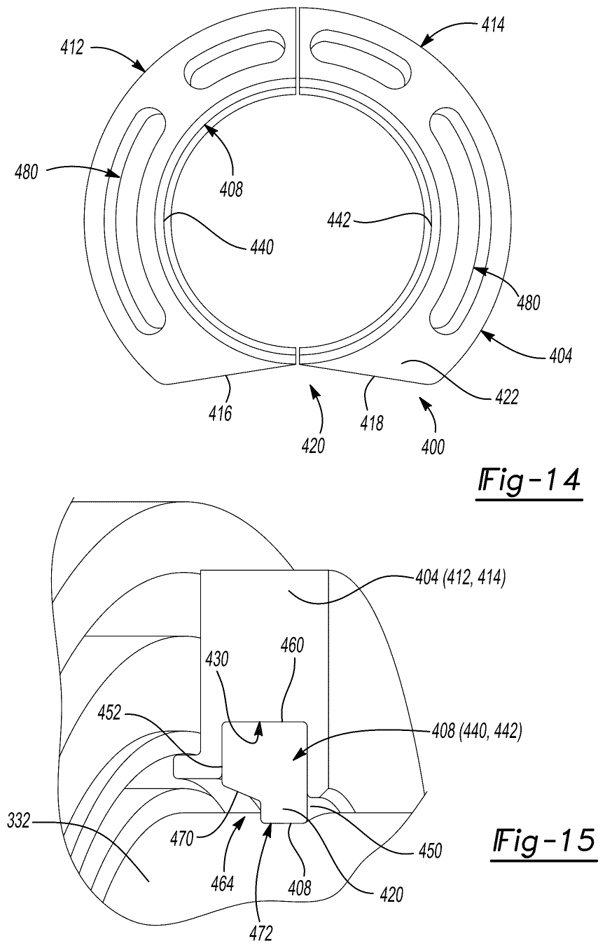

Scraper assembly 400 includes a collar 404 that supports a scraper ring 408 (FIG. 14). In a manner similar to that described herein, collar 404 includes at least two distinct pieces that are joined or coupled together during assembly. In this way, the scraper assembly 400 may be removably installed to the hydraulic cylinder assembly 322 after the assembly of the work vehicle 10 (e.g., by retrofitting at a dealership or after-market facility), thereby eliminating or reducing the additional work required to service and retrofit the hydraulic cylinder assembly 322 to install a scraper assembly 400.

For example, the scraper assembly 400 may be installed and/or removed from the hydraulic cylinder assembly 322 without disassembling the hydraulic cylinder assembly 322. It follows that the scraper assembly 400 facilitates efficient and cost-effective assembly onto and removal from the hydraulic cylinder assembly 322 compared to conventional assemblies that may require a disassembly of the hydraulic cylinder to a greater extent.

As also discussed herein, collar 404 may be formed of a metallic material, a polymeric material, or a composite material. Collar 404 includes a first collar 412 (e.g., a first partially semi-circular collar) and a second collar 414 (e.g., a second partial semi-circular collar) (collectively “collar 404”). First collar 412 includes a first discontinuity 416 and second collar 414 includes a second discontinuity 418. When first collar 412 and second collar 414 are brought together, first discontinuity 416 and second discontinuity 418 form a V-shaped notch section 420. Collar 404 is also shown to extend between a first face surface 422 and a second face surface 424 that is opposite to first face surface 422.

Collar 404 includes an outer surface 426 and an inner surface 428 spaced radially inward from the outer surface 66. Inner surface 428 is substantially annular and includes a recess or annular groove 430. A scraper ring 408 is nested within annular groove 430. Collar 404 is secured to retention member 344 through the plurality of fasteners 384. The plurality of fasteners 384 pass through plate 378, through collar 404, through seal guard 360 and thread into retention member 344 as shown in FIG. 14.

Scraper ring 408 is formed of a metallic material. The metallic material may include brass, copper, zinc, lead, tin, manganese, nickel, iron, alloys thereof, and/or combinations thereof. Scraper ring 408 is configured to prevent or inhibit debris from entering the cylinder 330 by contacting or “scraping” the outer surface (not separately labeled) of rod 32 as shown in FIG. 15. More specifically, as rod 332 moves between its fully extended and fully retracted positions, scraper ring 408 glides along the outer surface removing debris. As such, scraper ring 408 must exhibit a hardness, strength, and durability sufficient to effectively remove debris from the rod 332 while, at the same time, minimizing wear (e.g., scratching) of the rod 332.

As shown in FIG. 14, scraper ring 408 includes a first ring 440 (e.g., a first semi-circular ring) and a second ring 442 (e.g., a second semi-circular ring). As shown in FIG. 15, first ring 440 and second ring 442 extend between a first ring surface 450 and an axially extending spaced second ring surface 452. Scraper ring 408 includes an outer ring surface 460 and an inner ring surface 462. A flange or step 464 extends radially inward from the inner ring surface 462. The step 464 defines a first or cavity portion 470 and a second or rod engaging portion 472.

Collar 404 includes a plurality of openings 480 that extend through first face surface 422 and second face surface 424. Each of the plurality of openings 480 is an elongated opening. In accordance with an aspect of the present disclosure, each elongated opening includes a curvilinear profile. With this construction, plurality of fasteners 384 may easily register with retention member 344 and accommodate any rotational misalignment that may exist.

At this point, it should be understood, that scraper ring 408 may be readily installed without the need to open hydraulic cylinder assembly 322. That is, all installation requires is the removal and replacement of the plurality of fasteners 384 and plate 378. By maintaining hydraulic cylinder closed, scraper ring 408 lends itself to field installation and maintenance. Further, the installation of scraper ring 408 takes less time than conventional scrapers and thus is a more cost effective solution to minimizing damage to hydraulic components.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A hydraulic cylinder for a work vehicle, the hydraulic cylinder comprising:
a cylinder extending between a first end and a second end, the cylinder including a retention member positioned adjacent to the first end, the retention member including a plurality of threaded openings;
a rod slidingly disposed in the cylinder; and
a scraper assembly circumscribing the cylinder and the rod, the scraper assembly comprising:
a collar arranged at the first end of the cylinder, the collar including a first face surface and a second face surface axially spaced from the first face surface, the collar including a plurality of openings extending through the first face surface and the second face surface;
a scraper ring supported by the collar; and
a plurality of fasteners joining the collar to the cylinder, each of the plurality of fasteners extending through a corresponding one of the plurality of openings in the collar and engaging a corresponding one of the plurality of threaded openings in the retention member.

2. The hydraulic cylinder of claim 1, wherein the collar includes a first collar portion and a second collar portion, the first collar portion including a first discontinuity and the second collar portion including a second discontinuity, wherein when mounted to the cylinder, the first discontinuity and the second discontinuity form a V-shaped notch section in the collar.

3. The hydraulic cylinder of claim 1, wherein the collar includes an outer surface and an annular inner surface radially spaced from the outer surface, the annular inner surface including an annular groove that is receptive of the scraper ring.

4. The hydraulic cylinder according to claim 2, further comprising a plate positioned on the first face surface of the collar, the plurality of fasteners passing through the plate and the collar and engaging the threaded openings in the retention member.

5. The hydraulic cylinder according to claim 4, wherein the plate includes a partially annular surface including a plate discontinuity.

6. The hydraulic cylinder according to claim 5, wherein, when the plate is mounted to the first face surface, the plate discontinuity is aligned with the V-shaped notch section in the collar.

7. The hydraulic cylinder according to claim 6, further comprising a sensor housing mounted at the first end, the V-shaped notch section extending about a portion of the sensor housing.

8. The hydraulic cylinder according to claim 1, wherein the plurality of openings comprises a plurality of elongated openings.

9. The hydraulic cylinder according to claim 8, wherein each of the plurality of elongated openings includes a curvilinear profile.

10. A hydraulic cylinder for a work vehicle, the hydraulic cylinder comprising:
a cylinder extending between a first end and a second end;
a retention member mounted at the first end of the cylinder;
a rod slidingly disposed in the cylinder;
a sensor housing mounted at the first end of the hydraulic cylinder; and
a scraper assembly circumscribing the cylinder and the rod, the scraper assembly comprising:
a collar extending arranged at the first end of the cylinder, the collar including a V-shaped notch portion that extends about a portion of the sensor housing; and
a scraper ring mounted in the collar, the scraper ring engaging the rod.

11. The hydraulic cylinder according to claim 10, wherein the collar includes a first face surface, a second face surface axially spaced from the first face surface, and plurality of openings extending through the first face surface and the second face surface.

12. The hydraulic cylinder according to claim 11, wherein the retention member includes a plurality of threaded openings.

13. The hydraulic cylinder according to claim 12, further comprising: a plurality of fasteners joining the collar to cylinder, each of the plurality of fasteners extending through a corresponding one of the plurality of openings in the collar and engaging a corresponding one of the plurality of threaded openings in the retention member.

14. The hydraulic cylinder according to claim 13, wherein each of the plurality of openings comprises an elongated opening.

15. The hydraulic cylinder according to claim 14, wherein the elongated opening includes a curvilinear profile.

16. A method of assembling a scraper assembly onto a hydraulic cylinder for a work vehicle, the method comprising:
positioning collar including a plurality of openings and a scraper ring about a rod at a first end of the hydraulic cylinder;
rotating the collar to align the plurality of openings in the collar with a plurality of opening elements formed in a retention member mounted to the first end of the hydraulic cylinder;
passing a fastener through each of the plurality of openings in the collar into each of the plurality of opening elements in the retention member; and
tightening the fastener.

17. The method of claim 16, wherein rotating the collar includes aligning a V-shaped notch portion in the collar with a sensor housing mounted at the first end of the hydraulic cylinder.

18. The method of claim 16, wherein positioning the collar includes placing a plate on the collar.

19. The method of claim 18, wherein passing the fastener through each of the plurality of openings in the collar includes first passing the fastener through an opening formed in the plate arranged on the collar.

20. The method of claim 16, wherein rotating the collar includes aligning a plurality of elongated openings defining the plurality of openings in the collar with a plurality of threaded openings defining the plurality of openings in the retention member.
